(19) United States
(12) Patent Application Publication
(10) Pub. No.: US 2002/0178116 A1
(43) Pub. Date: Nov. 28, 2002

(54) Imaging system, imaging method, image service system and image service method

(76) Inventor: Masafumi Yamasaki, Hachioji-shi (JP)

Correspondence Address: STRAUB & POKOTYLO, 1 BETHANY ROAD, SUITE 83, BUILDING 6, HAZLET, NJ, 07730, US

(21) Appl. No.: 10/147,169

(22) Filed: May 16, 2002

(30) Foreign Application Priority Data
May 22, 2001 (JP) 2001-152837
May 22, 2001 (JP) 2001-152839

(51) Int. Cl. G06F 17/60

(52) U.S. Cl. 705/39

(57) ABSTRACT

Each user can arbitrarily select and use one of a plurality of cameras on a network by only accessing a management center server from a user terminal via the Internet. For this reason, the user can acquire various images taken by the selected camera via the network. The server stores and manages a user identification code used to identify the user terminal or the user, and a camera identification code used to identify the camera selected by the user terminal or the owner of that camera in association with each other, and can charge a use fee for each camera.

### CROSS-REFERENCE TO RELATED APPLICATIONS

This application is based upon and claims the benefit of priority from the prior Japanese Patent Applications No. 2001-152837, filed May 22, 2001; and No. 2001-152839, filed May 22, 2001, the entire contents of both of which are incorporated herein by its reference.

### BACKGROUND OF THE INVENTION

1. Field of the Invention

The present invention relates to a technique capable of imaging by remote-controlling a camera via a communication line.

2. Description of the Related Art

In recent years, digital imaging devices such as digital still cameras, digital movie cameras, and the like have prevailed. As a result, image data obtained by imaging can be easily distributed via a network. However, only post-imaging processes of data can be easily done. In order to take photographs, the photographer himself or herself must go to the imaging site as in the use of a conventional film camera. For this reason, in order to take landscapes photographs and the like of beautiful spots all over the world, much time and cost are required to visit imaging sites. After the photographer reaches the imaging site, an image that he or she intended may not be obtained due to bad weather or the like.

Furthermore, as for imaging in a special environment such as aerial photographs, undersea photographs, aerospace photographs, or the like, it is difficult to bring a camera into such an environment. Hence, it is impossible to personally take such photographs.

On the other hand, various techniques for remote-controlling a camera are known. Of these techniques, a typical camera remote-control technique is a monitoring system that monitors pictures from cameras set at monitoring sites of roads, rivers, and the like (Jpn. Pat. Appln. KOKAI Publication Nos. 2000-217169 and 2001-94967).

Such monitoring system continuously takes pictures at the monitoring sites for, e.g., 24 hours. The monitoring system sends these pictures to a monitoring center in real time via a communication line. For this reason, a supervisor can monitor images of the monitoring sites without actually going to these sites.

However, it is difficult to personally use such remote-control monitoring system upon imaging. In order to obtain an image via remote control, a person must prepare imaging hardware such as a camera and a communication device, thus requiring huge cost. Furthermore, pictures provided by the aforementioned remote-control monitoring system are suitable for the purpose of monitoring. Therefore, each camera is normally operating under a predetermined imaging condition. As a result, various imaging conditions according to the photographer's choice, e.g., the shutter speed, shutter timing, and the like, cannot be designated.

### BRIEF SUMMARY OF THE INVENTION

It is an object of the present invention to provide an imaging system, imaging method, image service system, and image service method, which allow the user to easily obtain desired images of various genres without going to imaging sites as if he or she took pictures at an imaging site by himself or herself.

To achieve the above object, according to a first aspect of the present invention, there is provided an imaging system comprising: a plurality of cameras; and a terminal used to control the plurality of cameras, the terminal comprising: selection means for selecting one of the plurality of cameras; display means for displaying a control panel used to control the camera selected by the selection means; and control information sending means for sending control information to the selected camera in accordance with operation at the control panel, and each of the plurality of cameras comprising: control means for controlling the camera in accordance with the control information sent from the terminal.

According to a second aspect of the present invention, there is provided an imaging method applied to a system which comprises a plurality of cameras, and a terminal used to control the plurality of cameras, and provides an imaging service using the plurality of cameras, the method comprising: a step of selecting a one of the plurality of cameras; a step of displaying a control panel used to control the selected camera on display means; a step of sending control information to the selected camera in accordance with operation at the control panel; and a step of controlling camera operations in accordance with the control information sent from the terminal.

According to a third aspect of the present invention, there is provided an image service system which interconnects a plurality of cameras and a user terminal used to select one of the plurality of cameras via a network; sends an image of the selected camera to the user terminal, the system comprising: means for receiving an image taken by the camera selected by the user terminal in response to a predetermined operation at the user terminal via the network; means for storing the image received; and management means for managing a user identification code and a camera identification code to charge a fee for using the selected camera, wherein the user identification code is used to identify the user terminal or a user of the user terminal, and the camera identification code is used to identify the selected camera or an owner of the camera.

According to a fourth aspect of the present invention, there is provided an image service method applied to a system which interconnects a plurality of cameras and a user terminal used to select one of the plurality of cameras via a network, and sends an image of the selected camera to the user terminal, the method comprising: a step of receiving an image taken by the camera selected by the user terminal in response to a predetermined operation at the user terminal via the network; a step of storing the received image; and a step of managing a user identification code and a camera identification code to charge a fee for using the selected camera, wherein the user identification code is used to identify the user terminal or a user of the user terminal, and the camera identification code is used to identify the selected camera or an owner of the selected camera.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the overall arrangement of a system according to an embodiment of the present invention;

FIG. 2 is a block diagram showing the arrangement of a management center provided in the system according to the embodiment of the present invention;

FIG. 3 is a block diagram showing the arrangement of a server provided at the management center shown in FIG. 2;

FIG. 4 shows an example of information which is sent from a user's control terminal to the center in the system according to the embodiment of the present invention;

FIG. 5 is a block diagram showing the arrangement of a camera used in the system according to the embodiment of the present invention;

FIG. 6 is a flowchart showing the operation of the user's control terminal in the system according to the embodiment of the present invention;

FIGS. 7A, 7B, 7C, and 7D show examples of image category information sent from the center to the user's control terminal in the system according to the embodiment of the present invention;

FIG. 8 shows an example of a control window which is sent from the center to the user's control terminal in the system according to the embodiment of the present invention;

FIG. 9 is a flowchart showing the operation of the center in the system according to the embodiment of the present invention;

FIG. 10 is a flowchart showing the information sending operation from the center to the user's control terminal in the system according to the embodiment of the present invention;

FIG. 11 is a flowchart showing the camera registration operation in the system according to the embodiment of the present invention; and

FIG. 12 is a flowchart showing the user registration operation in the system according to the embodiment of the present invention.

### DETAILED DESCRIPTION OF THE INVENTION

A preferred embodiment of the present invention will be described hereinafter with reference to the accompanying drawings.

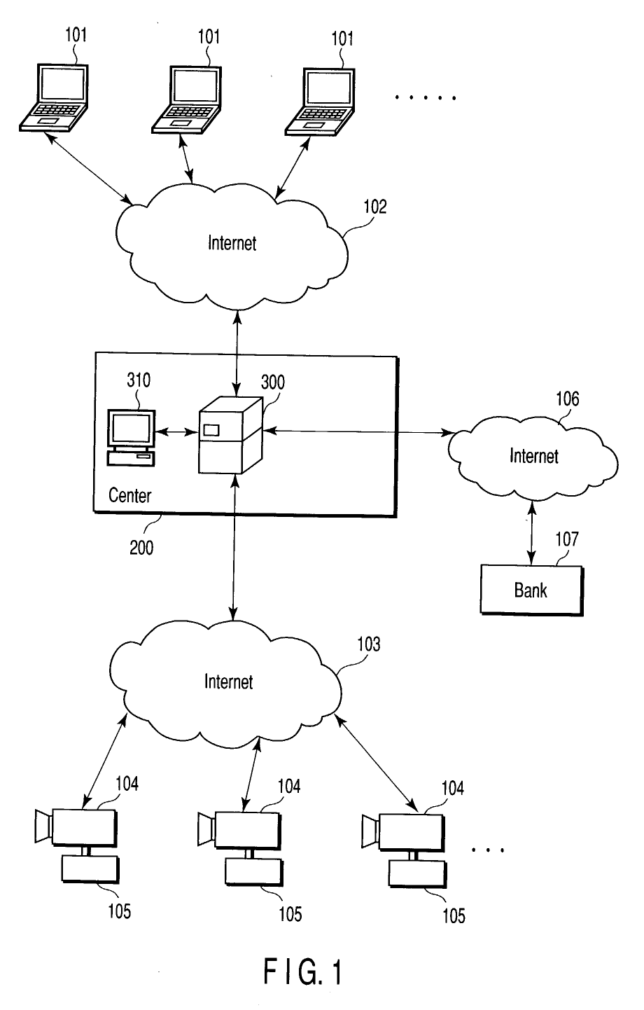

FIG. 1 shows the arrangement of an image service system. The user of this image service system can use a plurality of cameras on a network such as the Internet via this network. A user terminal 101 which comprises, e.g., a personal computer is connected to a server 300 in a management center 200 via the Internet 102. When the user has made a use contract of this system via a written or on-line sign-up procedure, information that pertains to the use contract is registered in the server 300 as user information. The user can then use services of this system.

The server 300 manages user information, information associated with cameras or information of camera owners (to be described later). The server 300 has a function of, e.g., storing/sending image information imaged in accordance with a user's request. The management center 200 has a terminal 310 used to manage the server 300.

The server 300 is connected to a plurality of cameras 104 via the Internet 103. When owners of these cameras 104 have made a contract with the center 200, camera identification information for identifying each of these cameras 104 is registered in the server 300. Together with the camera identification information, category information (e.g., “architecture”, “person”, “sea”, “mountain”, “space”, and the like) of images that can be imaged by that camera and representative sample images are stored in the server 300. The information associated with these cameras is sent to the user terminal 101 in a predetermined display format.

The server 300 is connected with the plurality of cameras 104, which may be owned by one or a plurality of owners. Each camera 104 is remote-controlled by the server 300, and an image taken by each camera 104 is sent to the user terminal 101 as a request source via the server 300. That is, the server 300 receives a request for a camera to be used and control instructions associated with its imaging timing and the like from each user terminal 101, and executes processes for remote-controlling the selected camera in accordance with the control instructions, selecting images to be provided to the user terminal 101, and so forth.

The owner of each camera 104 selects the location of the camera and actually sets the camera. Therefore, the cameras 104 are set at beautiful spots all over the world, and on airplanes, ships, and the like that can take aerial photographs, undersea photographs, and the like. A panpod 105 connected to each camera 104 has a function of changing the imaging direction of the camera 104 via remote control in accordance with a user's request.

A user's imaging method includes two methods, i.e., first and second imaging modes. In the first imaging mode, the user receives an image taken by the selected camera 104, and makes predetermined operation when his or her desired image is displayed on the screen of his or her terminal 101. In response to this operation, the image displayed at that time is stored in a memory provided in the server 300 of the center 200. In the second imaging mode, the server 300 remote-controls the camera 104 on the basis of control instructions from the user. The user takes a picture while adjusting the imaging direction, and the focus of an lens. The taken image is stored in the memory provided in the server 300 of the center 200. Some cameras 104 allow imaging in only the first imaging mode. Such cameras need only have a simple communication function of sending images such as still images, moving images, and the like.

The taken image stored in the server 300 is downloaded to the user terminal 101 later in accordance with a user's request. Of course, the taken image may be sent to the user terminal 101 without being stored in the server 300.

The server 300 calculates and manages the use fees of cameras for respective users on the basis of use fees which are different for respective cameras 104. This use fee is calculated in correspondence with the image quality of a taken image and the number of taken images. If imaging is done in the second imaging mode, a fee corresponding to the camera control time is added to that fee. This fee is transferred from the user's bank account registered in the center 200 upon contract to that of the owner of the camera that the user used in imaging. To achieve this process, the server 300 is connected to a bank 107 via the Internet 106, and the server 300 sends fee transfer information to the bank 107 via the Internet 106 on line. The bank account of the camera owner is registered in the center 200 when the camera owner has made a contract. Such charge information is stored in the server 300.

In this embodiment, the use fee of each camera 104 is automatically transferred to the bank account via a communication means but may be transferred via mail. In order to allow a specific user to pay a specific camera owner the use fee of a predetermined camera, a charge process associated with the use fees of the cameras 104 must be done by managing correspondence between the users and cameras used by the users. For this purpose, the server 300 must store a user identification code and camera identification code in association with the use fee of the selected camera. Note that the user identification code is used to identify the user terminal or user. The camera identification code is used to identify the selected camera or the owner of that camera. The user or camera identification code may be the bank account, or the server 300 may store the bank account in association with these identification codes. Of course, a charge process of the camera use fee for the user and a payment process of the use fee to each camera owner may be independently executed.

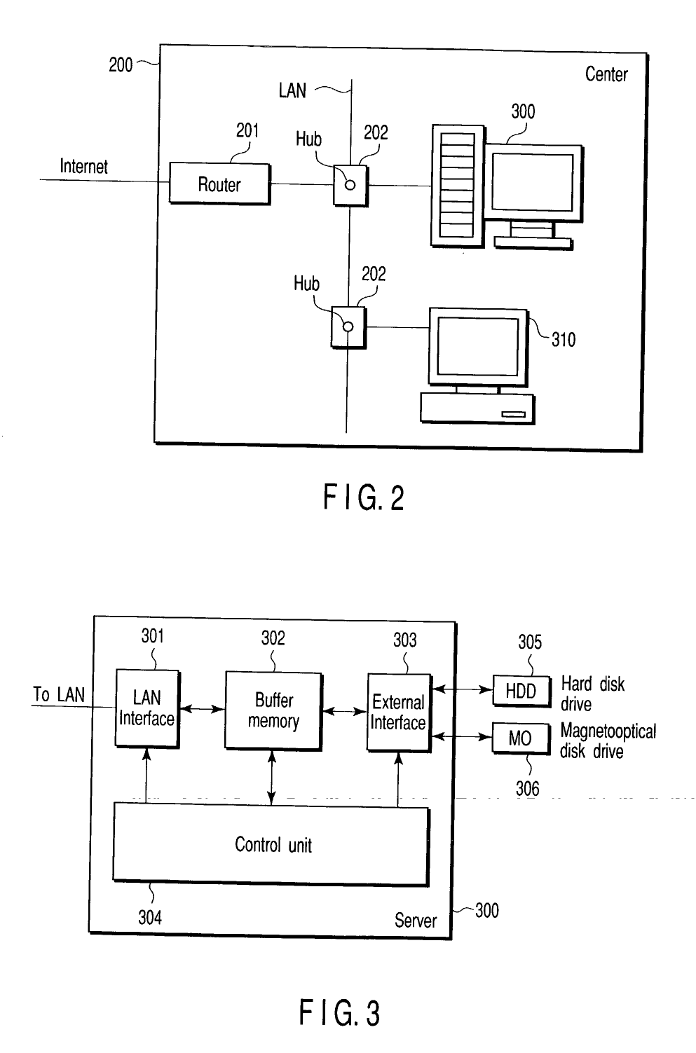

FIG. 2 shows the arrangement of the center 200. The server 300, the terminal 310, a router 201, and the like are connected to a LAN via hubs 202 and the like. The terminal 310 is used to manage various kinds of information stored in the server 300, and to manage other functions of the overall center 200. The router 201 is set at a branch point that connects a plurality of LANs, and has a high-level function of, e.g., determining packet routes. The router 201 is connected to the Internet.

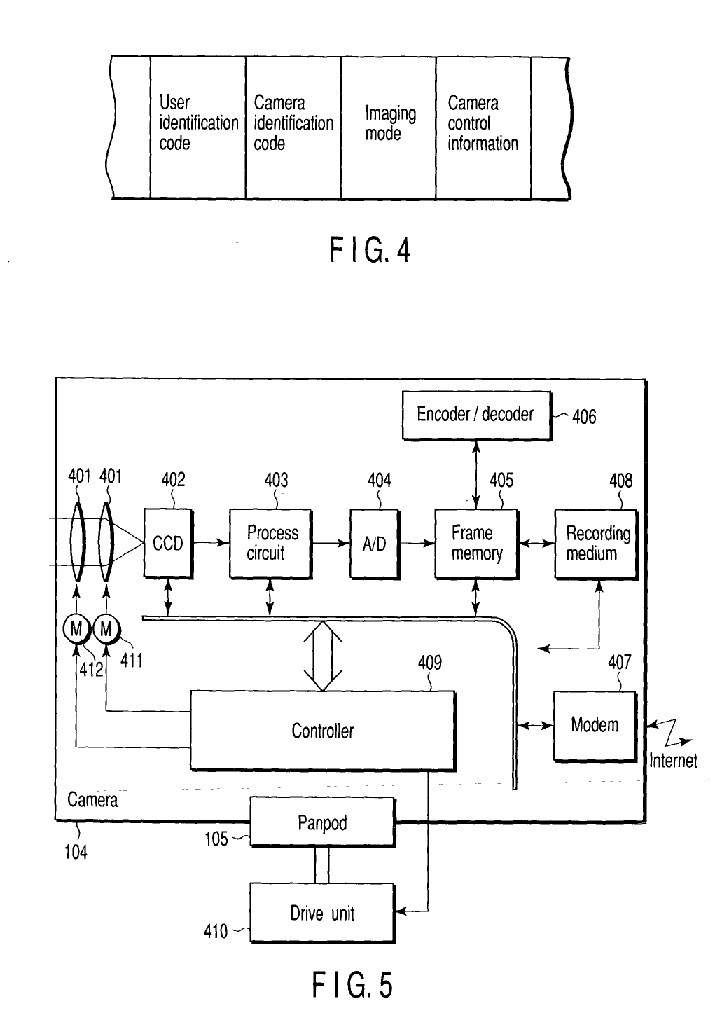

FIG. 3 shows the arrangement of the server 300. FIG. 4 shows the format of data sent from the user terminal 101.

The user confirms information associated with each of the plurality of cameras 104, category information of images which can be taken by the cameras 104, and the like, which are sent from the server 300, via a browser on his or her user terminal 101. The user selects a camera to be used in imaging, and sends information including a camera identification code, user identification code, and imaging mode to the server 300 in accordance with the format shown in FIG. 4 by predetermined operation.

The server 300 temporarily stores various kinds of information such as images externally input via the Internet and LAN in a buffer memory 302 via a LAN interface 301. Information stored in the buffer memory 302 is interpreted by a control unit 304. The control unit 304 receives a moving image from the camera 104 designated by the camera identification code via the LAN interface 301 and Internet, and temporarily stores it in the buffer 302. At the same time, the control unit 304 sends that moving image to the user terminal 101 as a request source. The user monitors the moving image displayed on the user terminal 101, and makes predetermined still image capture operation when a desired image is displayed on the monitor. In response to this operation, still image data corresponding to the operation timing is stored in that storage area of a magnetooptical disk drive 306, which corresponds to the user identification code. Note that the stored still image has a higher resolution than that of the moving image sent to the user terminal 101. This function can be implemented by outputting a low-resolution moving image from the camera 104 and outputting a high-resolution still image from the camera 104. Or the above function can also be implemented by the following control. That is, when the server 300 sends moving image data from the camera 104, which is stored in the buffer memory 302, to the user terminal 101, it sends a low-quality image via, e.g., a process for downsampling pixels of respective frames, and records a high-quality image as a still image by fully utilizing the performance of moving image data from the camera 104. Of course, image data to be sent to the user terminal 101 need not be a normal moving image, but may be a moving image which is displayed frame by frame.

In order to allow the user to pay the camera owner the use fee of the camera, a predetermined storage area of the magnetooptical disk 306 stores the user and camera identification codes, and the use fee of the selected camera in association with each other. Also, the user's bank account and that of the camera owner are also stored in a predetermined storage area of the magnetooptical disk 306 in correspondence with the user and camera identification codes.

FIG. 5 shows the arrangement of the camera 104. As the camera 104, either a digital still camera or digital movie can be used.

An object image formed on a CCD imaging device 402 via a lens 401 is converted by the CCD imaging device 402 into an electrical image signal. The image signal undergoes processes such as gamma correction and the like by a process circuit 403, and is then converted into a digital signal by an analog-to-digital converter 404. The digital image signal is temporarily stored in a frame memory 405. The image signal stored in the frame memory 405 is compressed by an encoder/decoder 406, and the compressed image signal is stored on a recording medium 408. The image data recorded on the recording medium 408 is sent to the center 200 via a modem 407 and the Internet. On the other hand, camera control information sent from the center 200 via the Internet is interpreted by a controller 409. Based on this control information, the controller 409 controls camera operations.

The camera 104 is mounted on the panpod 105, and a drive signal is output from the controller 409 to a drive unit 410 to direct the camera 104 in the direction instructed by the user. Also, a motor 411 adjusts focus control of the lens. This focus control is automatically executed. A motor 412 adjusts the focal length of the lens. With this adjustment, the field of view of a camera lens changes from the wide-angle end to the telephoto end.

The user confirms camera information, category information of an image taken by the camera, and the like, which are sent from the center 200, on his or her user terminal 101, and selects the camera he or she wants to use in imaging. The user then edits the camera and user identification codes and the control information of the camera 104 in a format shown in FIG. 4 by predetermined operation, and then sends such information to the center.

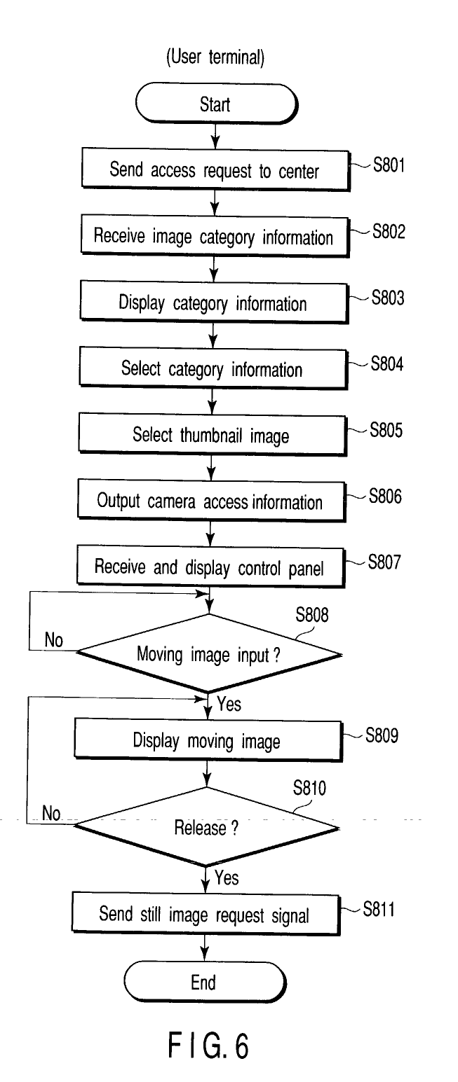

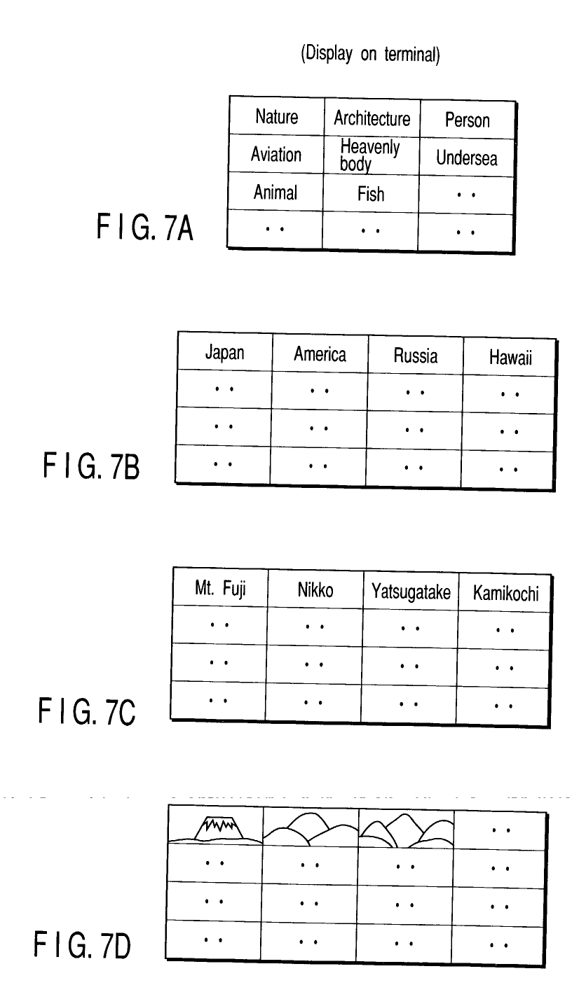

The control window provided to the user terminal 101 and the control method for that control window will be explained below with reference to FIGS. 6 and 7.

FIG. 6 is a flowchart showing the flow of operations in the user terminal 101. In step S801, the user terminal 101 issues an access request to the center 200. In steps S802 and S803, if this access request is accepted by the server 300 of the center 200, the server 300 sends image category information embedded with camera identification codes and the like. That information is received by the user terminal 101 and is displayed in the window. This image category information has a hierarchical structure, as shown in FIGS. 7A to 7D. Hence, the user can browse from generic category information to specific category information. In steps S804 and S805, generic category information (categories) including “nature”, “architecture”, “person”, “aviation”, “heavenly body”, and so on, shown in FIG. 7A is displayed. When the user double-clicks, e.g., a frame “nature” using the mouse, specific category information including “Japan”, “America”, and so on, shown in FIG. 7B is displayed. When the user selects, e.g., “Japan”, the names of beautiful spots like “Mt. Fuji”, “Nikko”, “Yatsugatake”, and so on, are displayed as more specific category information, as shown in FIG. 7C. When the user selects, e.g., “Mt. Fuji” from such category information, some image samples are displayed as thumbnails, as shown in FIG. 7D. The user selects a desired one of these thumbnail images. Note that information of a new camera registered in the center 200 is sent from the server 300 to the user terminal 101. That is, the identification code of the newly registered camera 104 is stored on a hard disk drive 305 of the center 200. Since this information also serves as an address used when the user selects a camera, if the new camera is registered, that information is sent from the server 300 to the user terminal 101. This camera information is sent together with a sample image. More specifically, the information may be sent while being buried in the category information.

Not only such category information but also camera use fees set for respective cameras are sent to the user terminal. The camera use fees are set in correspondence with image qualities, the types of objects, and the like, and are used as one of criteria when the user selects a camera.

When the user selects image category information and a sample image on the window, the camera used in imaging is selected. In step S806, camera access information including the camera identification code is sent from the user terminal 101 to the server 300 of the center 200 on the basis of the finally selected thumbnail image. The server 300 establishes connection between the user terminal 101 and the camera 104 selected by that user terminal 101, and sends control window information that allows the user to control the camera to the user terminal 101. Note that it is most efficient to establish connection between the user terminal 101 and camera 104 via the server 300. Alternatively, by providing a Web server function to each camera 104, the user terminal 101 and the selected camera 104 may be connected without the intervention of the center 200. In such a case, an address (URL) indicating that camera is used as the camera identification code.

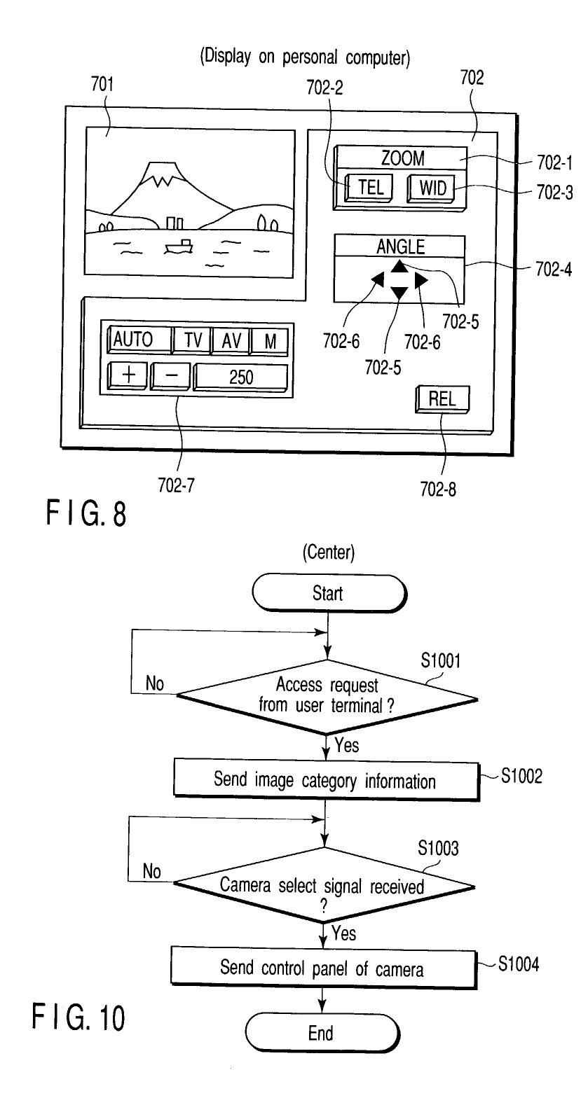

In step S807, the control window is displayed on the user terminal 101. FIG. 8 shows an example of the control window.

In the control window, an image display field 701 and control panel 702 are displayed. The image display field 701 displays a moving image sent from the connected camera 104. On the control panel 702, various control buttons are displayed. Different types of control buttons are displayed depending on the specifications of cameras. In the example of FIG. 8, a telephoto “TEL” button 702-2 and wide-angle “WID” button 702-3 are displayed on a frame 702-1 to allow zooming. Upon pressing the telephoto button 702-2, the lens of the camera 104 moves toward the telephoto end. Upon pressing the wide button 702-3, the lens of the camera 104 moves toward the wide-angle end. On an angle control frame 702-4 prepared to change the imaging direction of the camera, control buttons 702-5 used to turn the camera 104 in the pitch direction and control buttons 702-6 used to turn the camera 104 in the yaw direction are displayed. Control buttons 702-7 used to set an imaging mode include control buttons “AUTO”, “TV”, “AV”, “M”, and the like. The control button “AUTO” is used to select a fully automatic imaging mode. The control button “TV” is used to select a shutter-priority imaging mode. The control button “AV” is used to select an aperture-priority imaging mode. The control button “M” is used to select a manual mode. Also, control buttons “+” and “−” are used to increase or decrease a default value of each imaging mode. For example, in the shutter-priority mode, these buttons are used to increase or decrease the shutter speed. FIG. 8 shows an example wherein the shutter-priority mode is selected and the shutter speed is set at 1/250 sec. Also, the control panel 702 has a release button “REL” 702-8. When the user double-clicks this button, a still image taken by the camera 104 is stored in the magnetooptical disk 306 of the center 200 at the corresponding timing.

In steps S808 and S809, if the moving image is sent from the server 300 to the user terminal 101, it is displayed in the image display field 701 in the control window. In steps S810 and S811, if the user has double-clicked the release button 702-8, a still image request signal is sent from the user terminal 101 to the server 300. In response to this signal, the server 300 outputs a still image request signal to the camera 104, and a still image taken by the camera 104 is stored in a user-dedicated area of the magnetooptical disk 306 of the center 200.

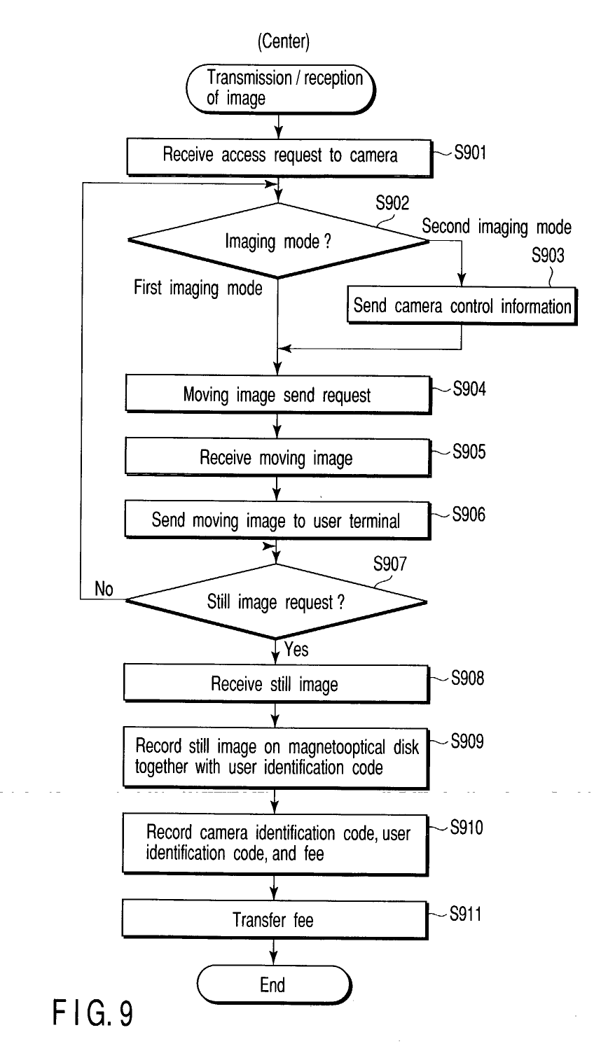

The flow of data transmission/reception in the server 300 will be described below with reference to the flowchart in FIG. 9.

In step S901, data shown in FIG. 4 is input from the user terminal 101. In steps S902 to S906, data indicating the imaging mode in the data is read. If the first imaging mode is designated, the server 300 issues a moving image send request to the selected camera 104 without controlling the camera 104. The server 300 receives a moving image from the camera, and then sends it to the user terminal 101. If the second imaging mode is designated, the server 300 sends camera control information corresponding to the user's control mode on the control panel 702 to the camera 104 in step S903. The camera 104 receives this camera control information, and then controls the panpod 105 to set the designated camera direction and drives the lens to set a designated zoom ratio. In step S904, the server 300 sends a moving image send request to the camera 104. Upon receiving the moving image from the camera 104 in step S905, the server 300 sends that moving image to the user terminal 101 in step S906. The server 300 then checks in step S907 if a still image request signal is received from the user terminal 101. If it is determined in step S907 that the still image request signal is not received, the processes from step S901 are repeated. That is, transmission/reception of a moving image, remote control of the camera 104 based on the user's control made via the control panel, and the like are successively executed.

If it is determined in step S907 that the still image request signal is received, the server 300 sends an imaging instruction to the camera 104 in step S908. The server 300 receives a taken still image from the camera 104. In step S909, the server 300 stores the received still image on the magnetooptical disk 306 together with the user identification code. In step S910, the server 300 stores the camera and user identification codes, and the camera use fee in a predetermined storage area of the magnetooptical disk 306 together. In step S911, the server 300 sends a signal to a server of a predetermined bank so that the camera use fee is transferred from the user's account to that of the camera owner. That is, the server 300 charges each user the use fee of the camera he or she used, and pays the camera owner for the use of the camera.

FIG. 10 is a flowchart showing the operation for sending image category information and the camera control panel from the center 200 to the user terminal 101. The server 300 of the center 200 checks in step S1001 if an access request signal to the center 200 is received from the user terminal 101. If it is determined in step S1001 that the access request is received, the server 300 sends image category information to the user terminal 101 as a request source in step S1002. The server 300 checks in step S1003 if a camera select signal is received from the user terminal 101. More specifically, the server 300 checks if the camera identification code shown in FIG. 4 is received. Upon receiving this signal, the server 300 sends the camera control panel to the user terminal 101 in step S1004.

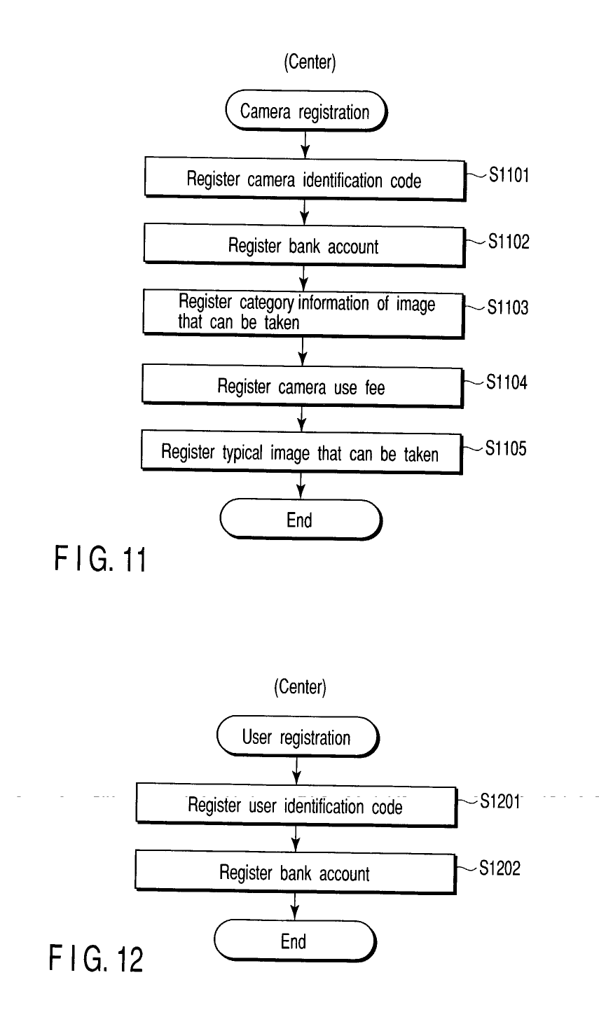

FIG. 11 is a flowchart showing the flow of the camera registration process in the center 200. In step S1101, a camera identification code is registered. This camera identification code must be unique to each camera. In step S1102, the bank account of the camera owner as a transfer destination of the camera use fee is registered. In step S1103, category information of images which can be taken by that camera (e.g., “architecture”, “person”, “sea”, “mountain”, “space”, or the like) is registered. In step S1104, the camera use fee is registered. The camera use fee is determined in correspondence with image quality and the type of object. In step S1105, typical sample images that can be taken by the camera are registered. These sample images are registered to allow the user to easily select a camera used in imaging. Such information is stored on the hard disk drive 305 shown in FIG. 3.

FIG. 12 is a flowchart for user registration in the center 200.

In step S1201, a user identification code is registered. In step S1202, a bank account required for the user to pay for the use fee of the camera is registered. Note that a password and the like are registered as needed.

As described above, in the system of this embodiment, the server 300 provides a camera select window and control window required to control the camera to the user terminal 101. The user can control imaging of the camera 104 selected at the user terminal 101 on the basis of control via the control window. The user can arbitrarily select and use one of a plurality of cameras 104 on the network by only accessing the center 200 from the user terminal 101 via the network.

Especially, since a charge process is made using information indicating the user terminal and the camera used by that user terminal, the user can be charged for the camera he or she used. Also, the use amount of the camera is clarified for each camera owner, a camera use fee corresponding to the use amount of the camera can be paid.

Note that the camera 104 and user terminal 101 can be connected without the intervention of the center 200. In this case, the user terminal 101 has an arrangement including the function of the server 300. For this reason, the camera control information from the user terminal 101 is directly sent to the selected camera 104, and an image taken by that camera 104 is directly sent to the user terminal.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An imaging system comprising:
a plurality of cameras; and
a terminal used to control said plurality of cameras, said terminal comprising:
selection means for selecting one of said plurality of cameras;
display means for displaying a control panel used to control the camera selected by said selection means; and
control information sending means for sending control information to the selected camera in accordance with operation at the control panel, and
each of said plurality of cameras comprising:
control means for controlling the camera in accordance with the control information sent from said terminal.

2. An imaging system according to claim 1, wherein each of said plurality of cameras comprises moving image sending means for sending a moving image taken by the camera to said terminal, and said terminal displays the moving image in the same window as said display means displays the control panel.

3. An imaging system according to claim 2, wherein said terminal further comprises:
operating means for extracting a still image from the moving image; and
image storage means for storing the still image extracted.

4. An imaging system according to claim 2, which further comprises a management center, and in which said plurality of cameras and said terminal are connected via said management center, the control panel of said terminal has operating means for extracting a still image from the moving image, and said management center comprises an image storage device for storing the extracted still image.

5. An imaging system according to claim 1, which further comprises a management center, and in which said plurality of cameras and said terminal are connected via said management center, and said management center comprises storage means for storing fee data corresponding to use of a camera by a user who is an owner of said terminal.

6. An imaging system according to claim 1, which further comprises a management center, and in which said plurality of cameras and said terminal are connected via said management center having display information of the control panel, and said terminal comprises reception means for receiving from said management center information of the control panel associated with the camera selected by said terminal.

7. An imaging system comprising:
a plurality of cameras; and
a terminal used to control said plurality of cameras, said terminal comprising:
storage means for storing category information indicating types of images;
category information display means for displaying the category information in the form of text or images;
designation means for designating one of images of the category information displayed by said category information display means;
selection means for selecting a camera that provides the image designated by said designation means, on the basis of the category information;
control panel display means for displaying a control panel used to control the camera selected by said selection means; and
sending means for sending control information to the selected camera in accordance with operation at the control panel, and
each of said plurality of cameras comprises control means for controlling the camera in accordance with the control information sent from said terminal.

8. An imaging system according to claim 7, wherein each of said plurality of cameras comprises moving image sending means for sending a moving image taken by the camera to said terminal, and
said terminal displays the moving image in the same window as said display means displays the control panel.

9. An imaging system according to claim 8, wherein said terminal further comprises:
operating means for extracting a still image from the moving image; and
image storage means for storing the still image extracted.

10. An imaging system according to claim 8, which further comprises a management center, and in which said plurality of cameras and said terminal are connected via said management center, and said terminal comprises operating means for extracting a still image from the moving image, and said management center comprises an image storage device for storing the extracted still image.

11. An imaging system according to claim 7, which further comprises a management center, and in which said plurality of cameras and said terminal are connected via said management center, and said management center comprises storage means for storing fee data corresponding to use of a camera by a user who is an owner of said terminal.

12. An imaging system according to claim 7, which further comprises a management center, and in which said plurality of cameras and said terminal are connected via said management center having display information of the control panel, and said terminal comprises reception means for receiving from said management center information of the control panel associated with the camera selected by said terminal.

13. An imaging method applied to a system which comprises a plurality of cameras, and a terminal used to control said plurality of cameras, and provides an imaging service using said plurality of cameras, said method comprising:
a step of selecting a one of said plurality of cameras;
a step of displaying a control panel used to control the selected camera, on display means;
a step of sending control information to the selected camera in accordance with operation at the control panel; and
a step of controlling camera operations in accordance with the control information sent from said terminal.

14. An imaging method applied to a system which comprises a plurality of cameras, and a terminal used to control said plurality of cameras, and provides an imaging service using said plurality of cameras, said method comprising:
a step of reading category information indicating types of images, from storage means that stores and displaying the category information in the form of text or images, on category information display means;
a step of designating one of images of the category information displayed by the category information display means, by using designation means;
a step of selecting a camera that provides the image using selection means, on the basis of the category information designated by designation means;
a step of displaying a control panel used to control the camera selected by selection means, on control panel display means;
a step of sending control information to the selected camera in accordance with operation at the control panel, by sending means; and
a step of controlling camera operations in accordance with the control information sent from said terminal.

15. An image service system for selectively controlling operations of a plurality of cameras in accordance with a request input from each user terminal via a network, said system comprising:
means for making the user terminal select a camera used in imaging;
means for sending an image from the selected camera to the user terminal via the network;
means for making the user terminal designate an imaging condition of the selected camera; and
means for controlling the selected camera on the basis of the imaging condition.

16. An image service system according to claim 15, wherein the imaging condition of the camera includes at least one of a camera direction, zoom, and shutter timing.

17. An image service method for selectively controlling operations of a plurality of cameras in accordance with a request input from each user terminal via a network, said method comprising:
a step of making the user terminal select a camera used in imaging;
a step of sending an image from the selected camera to the user terminal via the network;
a step of making the user terminal designate an imaging condition of the selected camera; and
a step of controlling the selected camera on the basis of the imaging condition.

18. An image service system which interconnects a plurality of cameras and a user terminal used to select one of the plurality of cameras via a network, and sends an image of the selected camera to the user terminal, said system comprising:
means for receiving an image taken by the camera selected by the user terminal, in response to a predetermined operation at the user terminal via the network;
means for storing the image received; and
management means for managing a user identification code and a camera identification code to charge a fee for using the selected camera,
wherein the user identification code is used to identify the user terminal or a user of the user terminal, and the camera identification code is used to identify the selected camera or an owner of the camera.

19. An image service system according to claim 18, wherein fees are independently set for the plurality of cameras, and
said management means stores the user identification code, the camera identification code, and a fee for using the camera connected to the user terminal.

20. An image service system according to claim 18, further comprising means for, when a new camera is registered in said image service system, sending information that pertains to the new camera to the user terminal.

21. An image service system according to claim 18, further comprising means for sending an image sample taken by the selected camera to the user terminal.

22. An image service system according to claim 19, further comprising means for sending the fee for using each of the plurality of cameras, to the user terminal.

23. An image service system according to claim 18, further comprising means for sending information required to transfer the fee from a bank account of the user to a bank account of the camera owner, on the basis of the user identification code and camera identification code managed by said management means.

24. An image service system according to claim 18, further comprising:
means for making the user terminal designate an imaging condition of the selected camera, and
means for controlling the selected camera via the network on the basis of the designated imaging condition.

25. An image service system which interconnects a plurality of cameras and a user terminal used to select one of the plurality of cameras via a network, and sends an image of the selected camera to the user terminal, said system comprising:
means for sending a moving image from the camera selected by the user terminal to the user terminal via the network;
means for extracting a image from the moving image on the basis of a predetermined operation at the user terminal;
means for storing a still image as a high-resolution image; and
management means for managing a user identification code and a camera identification code to charge a fee for using the selected camera,
wherein the user identification code is used to identify the user terminal or a user of the user terminal, and the camera identification code is used to identify the selected camera or an owner of the selected camera.

26. An image service system according to claim 25, wherein fees are independently set for the plurality of cameras, and
said management means stores the user identification code, the camera identification code, and a fee for using the camera connected to the user terminal.

27. An image service system according to claim 25, further comprising means for, when a new camera is registered in said image service system, sending information that pertains to the new camera to the user terminal.

28. An image service system according to claim 25, further comprising means for sending an image sample taken by the selected camera to the user terminal.

29. An image service system according to claim 26, further comprising means for sending the fee for using each of the plurality of cameras, to the user terminal.

30. An image service system according to claim 25, further comprising means for sending information required to transfer the fee from a bank account of the user to a bank account of the camera owner on the basis of the user identification code and the camera identification code managed by said management means.

31. An image service system according to claim 25, further comprising:
means for making the user terminal designate an imaging condition of the selected camera, and
means for controlling the selected camera via the network on the basis of the designated imaging condition.

32. An image service system which interconnects a plurality of cameras and a user terminal used to select one of the plurality of cameras via a network, and sends an image of the selected camera to the user terminal, said system comprising:
means for making the user terminal select a camera used in imaging;
means for sending an image from the selected camera to the user terminal via the network;
means for making the user terminal designate an imaging condition of the selected camera;
means for controlling the selected camera via the network on the basis of the imaging condition; and
managing means for managing information required to charge a camera use fee for each user terminal.

33. An image service system according to claim 32, further comprising means for managing information required to pay a fee to an owner of each camera.

34. An image service method applied to a system which interconnects a plurality of cameras and a user terminal used to select one of the plurality of cameras via a network, and sends an image of the selected camera to the user terminal, said method comprising:
a step of receiving an image taken by the camera selected by the user terminal, in response to a predetermined operation at the user terminal via the network;
a step of storing the received image; and
a step of managing a user identification code and a camera identification code to charge a fee for using the selected camera,
wherein the user identification code is used to identify the user terminal or a user of the user terminal, and the camera identification code is used to identify the selected camera or an owner of the selected camera.

35. An image service method according to claim 34, further comprising a step of sending information required to transfer the fee from a bank account of the user to a bank account of the camera owner, on the basis of the user identification code and the camera identification code.

36. An image service method according to claim 34, further comprising;
a step of making the user terminal designate an imaging condition of the selected camera, and
a step of controlling the selected camera via the network on the basis of the designated imaging condition.

37. An image service method applied to a system which interconnects a plurality of cameras and a user terminal used to select one of the plurality of cameras via a network, and sends an image of the selected camera to the user terminal, said method comprising:
a step of sending a moving image from the camera selected by the user terminal to the user terminal via the network;
a step of extracting a image from the moving image on the basis of a predetermined operation at the user terminal;
a step of storing a still image as a high-resolution image; and
a step of managing a user identification code and a camera identification code to charge a fee for using the selected camera,
wherein the user identification code is used to identify the user terminal or a user of the user terminal, and
the camera identification code is used to identify the selected camera or an owner of the selected camera.

38. An image service method according to claim 37, further comprising a step of sending information required to transfer the fee from a bank account of the user to a bank account of the camera owner on the basis of the user identification code and the camera identification code.

39. An image service method according to claim 37, further comprising:
a step of making the user terminal designate an imaging condition of the selected camera, and
a step of controlling the selected camera via the network on the basis of the designated imaging condition.

40. An image service method applied to a system which interconnects a plurality of cameras and a user terminal used to select one of the plurality of cameras via a network, and sends an image of the selected camera to the user terminal, said method comprising:
a step of making the user terminal select a camera used in imaging;
a step of sending an image from the selected camera to the user terminal via the network;
a step of making the user terminal designate an imaging condition of the selected camera;
a step of controlling the selected camera via the network on the basis of the imaging condition; and
a step of managing information required to charge a camera use fee for each user terminal.

41. An image service method according to claim 40, further comprising a step of managing information required to pay a fee to an owner of each camera.
